(19) United States
(12) Patent Application Publication
(10) Pub. No.: US 2016/0295088 A1
(43) Pub. Date: Oct. 6, 2016

(54) LIGHT EMITTING DEVICE, IMAGING DEVICE, AND PROGRAM

(71) Applicant: PIONEER CORPORATION, Kawasaki-shi (JP)

(72) Inventor: Shigehiro UMETSU, Yonezawa-shi (JP)

(21) Appl. No.: 14/907,411

(22) PCT Filed: Mar. 12, 2014
(86) PCT No.: PCT/JP2014/056525

§ 371 Date: May 17, 2016

(51) Int. Cl. H04N 5/235; H04N 9/04; G03B 15/05; H04N 5/238

(52) U.S. Cl. CPC H04N 5/2354; H04N 5/238; H04N 9/04; G03B 15/05

(57) ABSTRACT

A light emitting device (10) includes a lighting section (120) and a control section (140). An imaging device (20) includes an imaging section (220). The lighting section (120) is able to adjust a spectrum distribution of light and the intensity thereof, and emits light to a photographic subject (S) to be imaged by the imaging section (220). The control section (140) controls the lighting section (120). The control section (140) emits light to the photographic subject (S) before the imaging section (220) performs imaging. Further, the control section (140) increases the intensity of light emitted from the lighting section (120) when the imaging section (220) images the photographic subject (S).

### TECHNICAL FIELD

The present invention relates to a light emitting device, an imaging device, and a program.

### BACKGROUND ART

When imaging a photographic subject, the photographic subject is illuminated. In particular, at the moment that the imaging is performed, light emitted to the photographic subject may be increased using a flash light source (strobe).

For example, Patent Document 1 discloses a technique in which a strobe lighting device and an electric lamp are provided as separate light sources in a photo sticker vending machine. Further, Patent Document 1 also discloses a technique for adjusting a color tone of the strobe lighting device according to an input signal from a switch.

Further, Patent Document 2 discloses a technique capable of adjusting a color tone in a lighting system used in imaging. This lighting system is provided separately from a flash light source. Further, Patent Document 2 also discloses a technique capable of controlling the lighting system using a camera.

Further, Patent Document 3 discloses a technique in which plural flash devices having different chromaticity are provided and the ratio of light emission intensities of the plural flash devices is adjusted according to an environmental color around a photographic subject.

### RELATED DOCUMENT

### Patent Document

[Patent Document 1] Japanese Unexamined Patent Application Publication No. 2003-84356

[Patent Document 2] Japanese Unexamined Patent Application Publication No. 2012-204954

[Patent Document 3] Japanese Unexamined Patent Application Publication No. 2012-141445

### SUMMARY OF THE INVENTION

In general, a light emitting device that emits illumination to a photographic subject and a flash device that provides light to the photographic subject in imaging are provided as different devices. Thus, a spectrum distribution of the light emitted to the photographic subject when viewing the photographic subject and a spectrum distribution of the light emitted to the photographic subject when imaging the photographic subject become different from each other. In this case, there is a possibility that an impression given from an image of the photographic subject is different from an impression given from the photographic subject before imaging.

In order to solve such a problem, an object of the invention is to provide a technique capable of reducing the difference between a spectrum distribution of the light emitted to a photographic subject when viewing the photographic subject and a spectrum distribution of the light emitted to the photographic subject when imaging the photographic subject.

According to claim 1 of the invention, there is provided a light emitting device comprising:

a lighting section that is able to adjust a light spectrum distribution and a light intensity and emits light to a photographic subject to be imaged by an imaging section; and

a control section that controls the lighting section,

wherein the control section

emits light to the photographic subject before the imaging section performs imaging, and

increases a light emission intensity of the lighting section when the imaging section images the photographic subject.

According to claim 6 of the invention, there is provided an imaging device used together with a light emitting device. The light emitting device comprising:

a lighting section that is able to adjust a light spectrum distribution and a light intensity and emits light to a photographic subject to be imaged by an imaging section; and

a control section that controls the lighting section according to a signal received from the imaging device, and

the imaging device comprising:

an imaging section that images the photographic subject;

an imaging signal generation section that generates an imaging signal indicating that a light emission intensity of the lighting section will be increased when a signal indicating that the photographic subject will be imaged is received; and

a transmission section that transmits the imaging signal to the light emitting device.

According to claim 10 of the invention, there is provided a program used in an imaging device that is used together with a light emitting device, in which the light emitting device comprising:

a lighting section that is able to adjust a light spectrum distribution and a light intensity and emits light to a photographic subject to be imaged by an imaging section; and

a control section that controls the lighting section according to a signal received from the imaging device,

the program causing the imaging device to execute functions comprising:

a function of generating an imaging signal indicating that a light emission intensity of the lighting section will be increased when a signal indicating that the photographic subject will be imaged is received; and

a function of transmitting the imaging signal to the light emitting device.

### BRIEF DESCRIPTION OF THE DRAWINGS

The above objects and other objects, features and advantages will become apparent from preferred embodiments described below, and the accompanying drawings.

FIG. 1 is a diagram illustrating a configuration of a light emitting device according to a first embodiment.

FIG. 2 is a diagram illustrating an example of a configuration of a lighting section, in which a control section and a power source are shown together.

FIG. 3 is a flowchart illustrating an example of operations of a light emitting device and an imaging device.

FIG. 4 is a diagram illustrating a configuration of a light emitting device according to a second embodiment.

FIG. 5 is a diagram illustrating a configuration of an imaging system according to Example 1.

FIG. 6 is a flowchart illustrating an example of operations of a light emitting device and an imaging device shown in FIG. 5.

FIG. 7 is a diagram illustrating a configuration of an imaging system according to Example 2.

FIG. 8 is a diagram illustrating an example of a display in a display section.

FIG. 9 is a diagram illustrating an example of an imaging system according to Example 3.

FIG. 10 is a flowchart illustrating an example of an operation of the imaging system shown in FIG. 9.

FIG. 11 is a diagram illustrating a configuration of an imaging system according to Example 4.

### DESCRIPTION OF EMBODIMENTS

Hereinafter, embodiments of the invention will be described with reference to the accompanying drawings. In the drawings, the same reference numerals are given to the same components, and description thereof will not be repeated.

In the following description, respective components of a light emitting device 10 and respective components of an imaging device 20 do not show a hardware configuration, but show functional unit blocks. The respective components of the light emitting device 10 and the imaging device 20 are realized by an arbitrary combination of hardware and software using a CPU, a memory, a program loaded in the memory, a storage media such as a hard disk in which the program is stored, and a network connection interface of an arbitrary computer. Further, its realization method and device may have various modification examples.

### First Embodiment

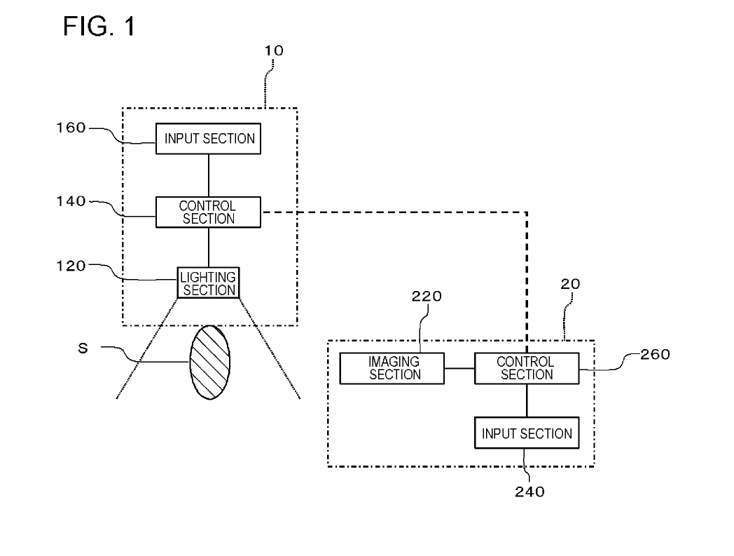

FIG. 1 is a diagram illustrating a configuration of the light emitting device 10 according to the first embodiment. The light emitting device 10 according to this embodiment forms one imaging system together with the imaging device 20, and includes a lighting section 120 and a control section 140. The imaging device 20 includes an imaging section 220. The lighting section 120 is able to adjust at least one of a color temperature and a light spectrum distribution, and a light intensity, and emits light to a photographic subject S to be imaged by the imaging section 220. The control section 140 controls the lighting section 120. The control section 140 emits light to the photographic subject S before the imaging section 220 performs imaging. Further, the control section 140 increases a light emission intensity of the lighting section 120 when the imaging section 220 images the photographic subject S. Hereinafter, the description will be made in detail under the assumption that the lighting section 120 is able to control each of a color temperature, a light spectrum distribution, and a light intensity.

The lighting section 120 includes plural types of light emitting elements having different colors, for example. These light emitting elements are organic EL elements, for example, but maybe LEDs. The control section 140 independently controls light emission intensities of the plural types of light emitting elements, to control a color temperature, a light spectrum distribution, and the light intensity of the lighting section 120.

Further, the control section 140 controls the light spectrum distribution of the lighting section 120 before the imaging section 220 performs imaging. The control section 140 increases the light emission intensity of the lighting section 120 while maintaining the light spectrum distribution of the lighting section 120 when the imaging section 220 images the photographic subject S. For example, the control section 140 increases the light emission intensity when the imaging section 220 images the photographic subject S by at least five times or more compared with an immediately previous light emission intensity.

Specifically, the light emitting device 10 includes an input section 160. The input section 160 receives an input from a user of the light emitting device 10. The input section 160 includes an input device such as input buttons or a touch panel, for example, and receives lighting control information from the user through the input device. Further, the control section 140 controls the color temperature and the light spectrum distribution of the lighting section 120 according to the lighting control information.

Further, the imaging device 20 includes an input section 240 and a control section 260. The input section 240 receives an input from a user of the imaging device 20. The input section 240 includes an input device such as input buttons or a touch panel, for example, and receives an imaging instruction indicating that imaging will be performed from the user through the input device. The input device may be a switch that interlocks with a mechanical shutter. The control section 260 controls the imaging section 220 according to the imaging instruction, and causes the imaging section 220 to generate image data.

In addition, when the imaging instruction is received from the input section 240, the control section 260 (an imaging signal generation section and a transmission section) generates an imaging signal indicating that imaging will be performed by the imaging section 220, and transmits the generated imaging signal to the control section 140 of the light emitting device 10. When the imaging signal is received from the control section 260, the control section 140 increases the light emission intensity of the lighting section 120 while maintaining the color temperature and the light spectrum distribution of the lighting section 120. That is, the lighting section 120 includes both of a lighting function with respect to the photographic subject S and a flash function in imaging.

The imaging device 20 may have functions other than the imaging section 220, the input section 240, and the control section 260. For example, the imaging device 20 may have a wireless communication function (for example, a sound communication function or a data communication function). In this case, the imaging device 20 may be a mobile phone (including a smart phone) with an imaging function.

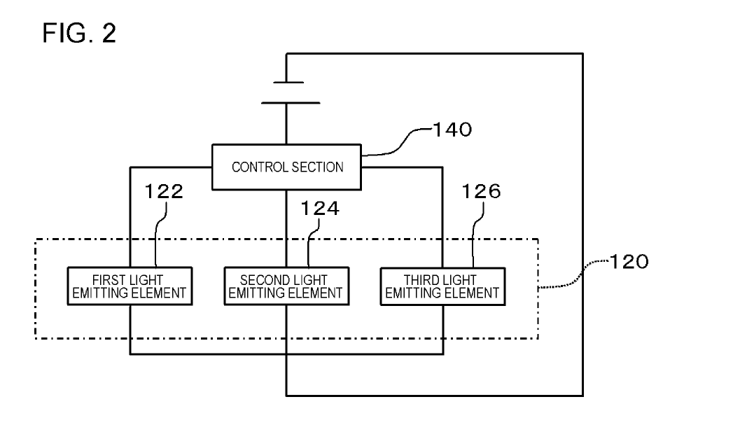

FIG. 2 is a diagram illustrating an example of a configuration of the lighting section 120 in which the control section 140 and a power source are shown together. In the example shown in FIG. 2, the lighting section 120 includes a first light emitting element 122, a second light emitting element 124, and a third light emitting element 126. The first light emitting element 122, the second light emitting element 124, and the third light emitting element 126 emit different colors (for example, red, green, and blue). Further, the control section 140 controls an amount of electric current flowing in the first light emitting element 122, the second light emitting element 124, and the third light emitting element 126.

Specifically, the control section 140 determines a relative ratio of the amount of electric current flowing in the first light emitting element 122, the second light emitting element 124, and the third light emitting element 126 according to the lighting control information input from the input section 160 shown in FIG. 1. Further, the control section 140 increases the amount of the electric current flowing in the first light emitting element 122, the second light emitting element 124, and the third light emitting element 126 while maintaining the relative ratio of the amount of the electric current when the imaging section 220 performs imaging. When increasing the amount of electric current flowing in the lighting section 120, the control section 140 may multiply the relative ratio of the amount of the electric current by a correction coefficient based on the amount of the electric current.

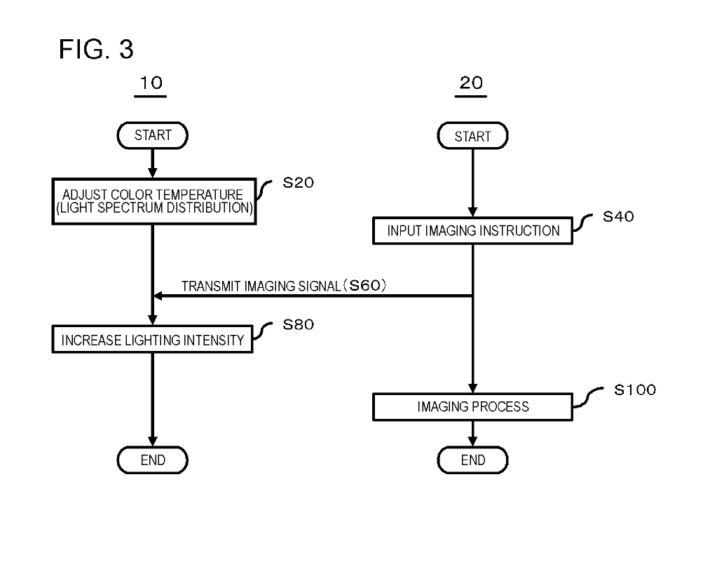

FIG. 3 is a flowchart illustrating an example of operations of the light emitting device 10 and the imaging device 20. First, a user inputs lighting control information to the light emitting device 10 through the input section 160. The control section 140 adjusts the color temperature and the light spectrum distribution of the lighting section 120 according to the lighting control information (step S20). Further, when an impression received from the photographic subject S is in a desired state, the user inputs an imaging instruction to the input section 240 of the imaging device 20 (step S40). Then, the control section 260 transmits an imaging signal to the control section 140 of the light emitting device 10 (step S60).

If the imaging signal is received, the control section 140 of the light emitting device 10 increases the light emission intensity of the lighting section 120 (step S80). Further, at the timing, the imaging section 220 of the imaging device 20 generates image data (step S100). A period of time during which the light emission intensity of the lighting section 120 increases is 0.1 msec to 10 msec, for example.

As described above, according to this embodiment, when the imaging section 220 of the imaging device 20 images the photographic subject S, the control section 140 increases the light emission intensity of the lighting section 120. In other words, the lighting section 120 includes both of the lighting function with respect to the photographic subject S and the flash function in imaging. Accordingly, it is possible to reduce a difference between a spectrum distribution (first spectrum distribution) of light emitted to a photographic subject when viewing the photographic subject and a spectrum distribution (second spectrum distribution) of light emitted to a photographic subject when imaging the photographic subject. Particularly, in this embodiment, since the control section 140 increases the light emission intensity of the lighting section 120 while maintaining the color temperature and the light spectrum distribution of the lighting section 120, it is possible to further reduce the difference between the first spectrum distribution and the second spectrum distribution.

Further, according to this embodiment, when the imaging signal is received from the imaging device 20, the control section 140 increases the light emission intensity of the lighting section 120. Accordingly, it is possible to easily match a timing at which the imaging section 220 generates image data and a timing at which the light emission intensity of the lighting section 120 is increased.

### Second Embodiment

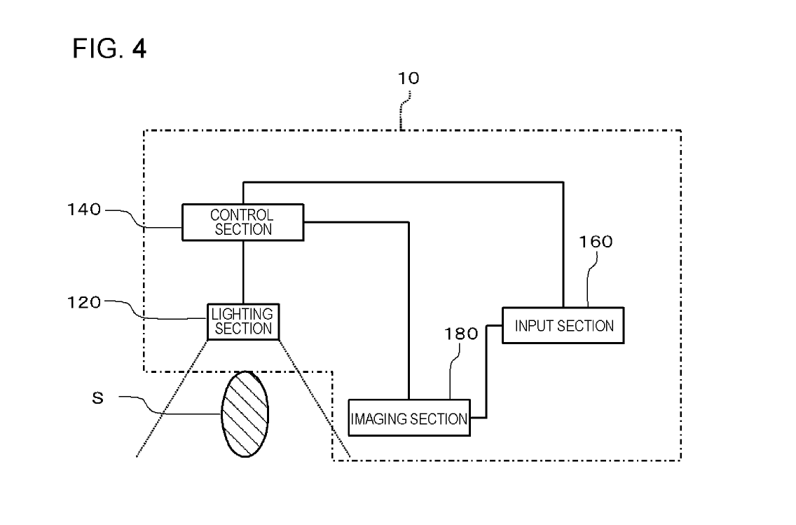

FIG. 4 is a diagram illustrating a configuration of the light emitting device 10 according to a second embodiment, and corresponds to the configuration shown FIG. 1 in the first embodiment. The light emitting device 10 according to this embodiment has the same configuration as in the light emitting device 10 according to the first embodiment, except for the following points.

First, the light emitting device 10 includes an imaging section 180. The imaging section 180 corresponds to the imaging section 220 in the first embodiment. Further, the control section 140 includes the function of the control section 260 in the first embodiment, and the input section 160 includes the function of the input section 240 in the first embodiment.

In this embodiment, similarly, when the imaging section 180 images a photographic subject S, the control section 140 increases the light emission intensity of the lighting section 120. Accordingly, it is possible to reduce a difference between a spectrum distribution (first spectrum distribution) of light emitted to a photographic subject when viewing the photographic subject, and a spectrum distribution (second spectrum distribution) of light emitted to a photographic subject when imaging the photographic subject.

### EXAMPLES

### Example 1

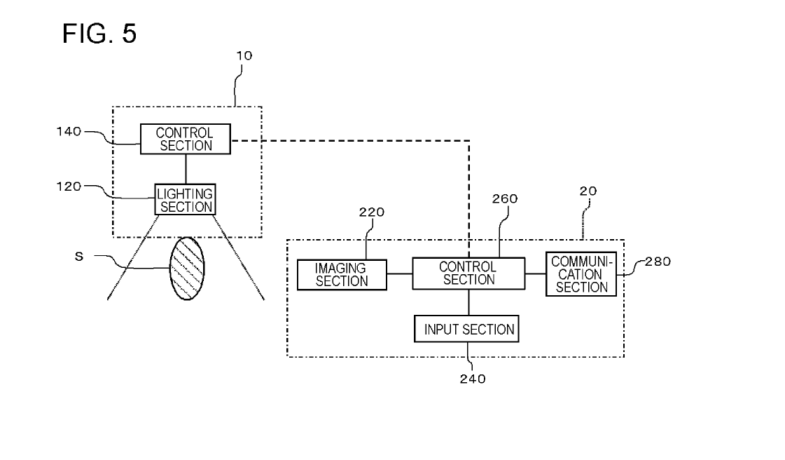

FIG. 5 is a diagram illustrating a configuration of an imaging system according to Example 1, and corresponds to the configuration shown in FIG. 1 in the first embodiment. The light emitting device 10 and the imaging device 20 according to this example have the same configuration as in the light emitting device 10 and the imaging device 20 in the first embodiment, except for the following points.

First, the light emitting device 10 does not include the input section 160. Instead, a user inputs a lighting control signal of the lighting section 120 to the imaging device 20.

Specifically, the user inputs a lighting control instruction to the imaging device 20 through the input section 240. Further, the control section 260 (lighting control signal generation section) generates a lighting control signal according to the lighting control instruction input through the input section 240, and transmits the generated lighting control signal to the control section 140 of the light emitting device 10.

Further, the control section 260 includes a function of generating an imaging signal (imaging signal generation section), similar to the first embodiment.

Further, the imaging device 20 includes a communication section 280. The communication section 280 accesses an external server through a communication network such as a wireless communication network, for example. Further, the communication section 280 downloads a program for causing the control section 260 to have the above-described functions, from the external server.

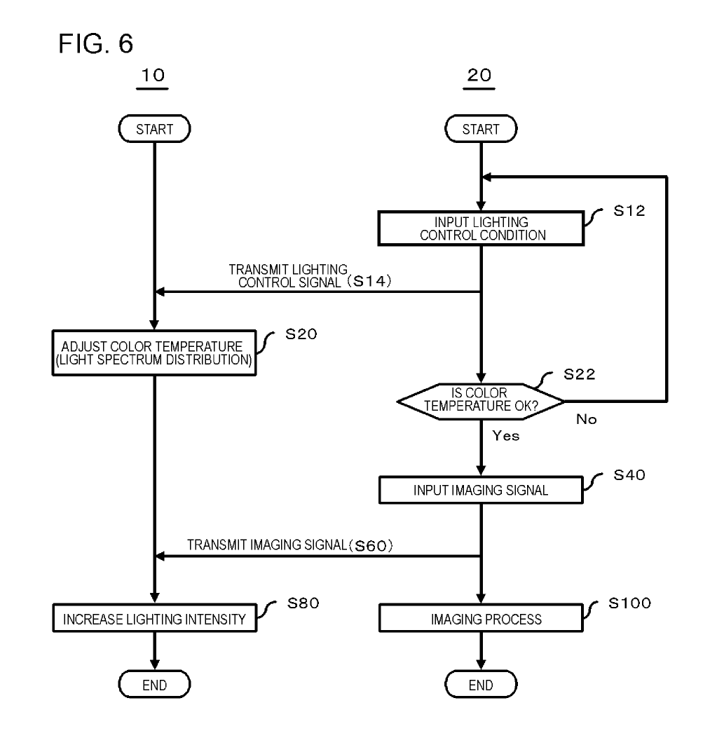

FIG. 6 is a flowchart illustrating an example of the operations of the light emitting device 10 and the imaging device 20 according to this embodiment. First, a user inputs a lighting control instruction to the light emitting device 10 through the input section 240 of the imaging device 20 (step S12). The input section 240 generates a lighting control signal, and transmits the generated lighting control signal to the control section 140 of the light emitting device 10 (step S14). The control section 140 adjusts the color temperature and the light spectrum distribution of the lighting section 120 according to the received lighting control signal (step S20). The user performs input (adjustment) of a lighting control condition until an impression received from the photographic subject S is in a desired state (step S22).

Subsequent processes (steps S40 to S100) are the same as in the first embodiment.

In this example, similarly, it is possible to reduce a difference between a spectrum distribution (first spectrum distribution) of light emitted to a photographic subject when viewing the photographic subject and a spectrum distribution (second spectrum) of light emitted to the photographic subject when imaging the photographic subject. Further, the user can perform both of the lighting control and the imaging by an input operation with respect to the imaging device 20. Thus, it is possible to reduce the workload applied to the user when imaging the photographic subject S.

### Example 2

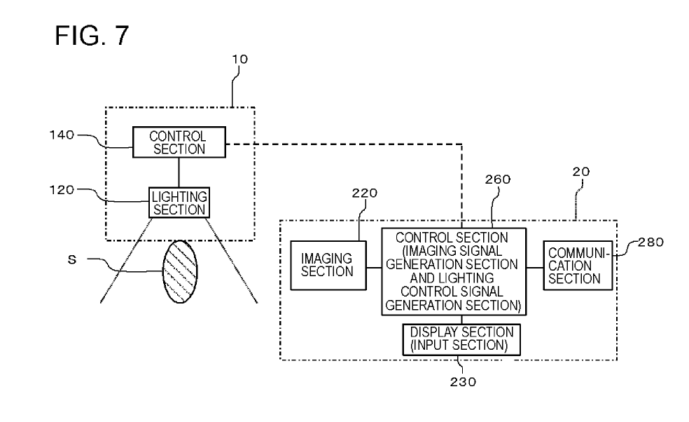

FIG. 7 is a diagram illustrating a configuration of an imaging system according to Example 2, and corresponds to the configuration shown in FIG. 5 in Example 1. The imaging system according to this example has the same configuration as in the imaging system according to Example 1, except that the imaging device 20 includes a display section 230 instead of the input section 240.

The display section 230 includes a touch panel, and functions as an input section. A user operates the touch panel of the display section 230 to input a lighting control instruction and an imaging instruction to the imaging device 20.

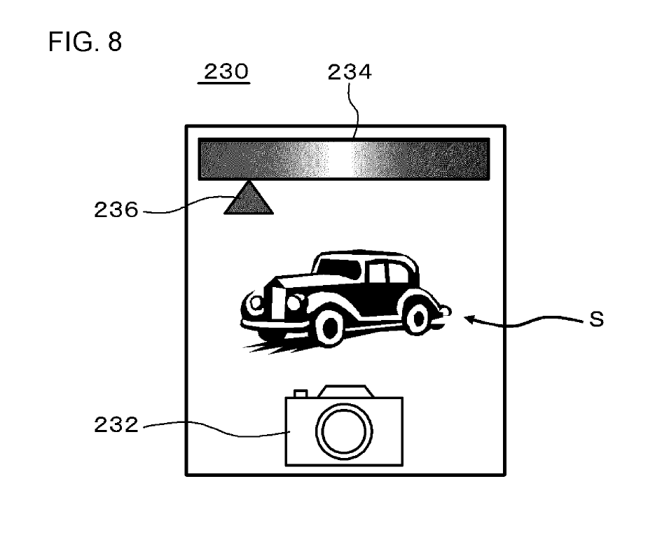

FIG. 8 is a diagram illustrating an example of a display in the display section 230. The display shown in FIG. 8 is displayed before image data is generated. In the display section 230, temporary image data generated by the imaging section 220 is displayed. The temporary image data includes a photographic subject S. Further, the display section 230 displays a display image (specifically, an icon 232) for input of an imaging instruction and a display image (specifically, a color display section 234 and a selection mark 236) for input of a lighting control instruction in the virtual image data in an overlay manner on the temporary image data. The user selects the icon 232 for imaging the photographic subject S. Further, plural colors are continuously displayed in the color display section 234. In addition, for inputting the lighting control instruction, the user moves the selection mark 236 so that the selection mark 236 indicates a desired color region in the color display section 234.

In this example, similarly, it is possible to reduce a difference between a spectrum distribution (first spectrum distribution) of light emitted to a photographic subject when viewing the photographic subject, and a spectrum distribution (second spectrum distribution) of light emitted to a photographic subject when imaging the photographic subject. Further, the user can perform the lighting control and the imaging by an input operation with respect to the imaging device 20. Thus, it is possible to reduce the workload applied to the user when the photographic subject S is imaged.

### Example 3

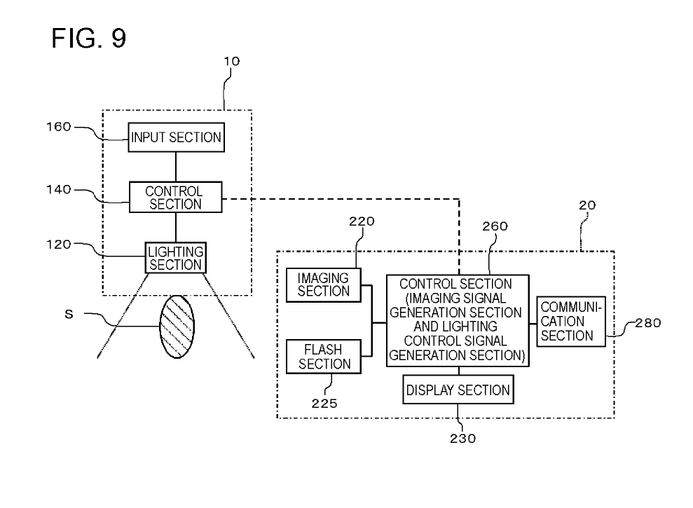

FIG. 9 is a diagram illustrating a configuration of an imaging system according to Example 3. The imaging system according to this example has the same configuration as in the imaging system in Example 2, except that the imaging device 20 includes a flash section 225.

The flash section 225 emits light at a timing at which the imaging section 220 generates image data in a state where the imaging device 20 is used independently of the light emitting device 10. On the other hand, the flash section 225 is not operated when the imaging device 20 is operated together with the light emitting device 10. In other words, the control section 260 inhibits the operation of the flash section 225 when an imaging signal is transmitted to the light emitting device 10.

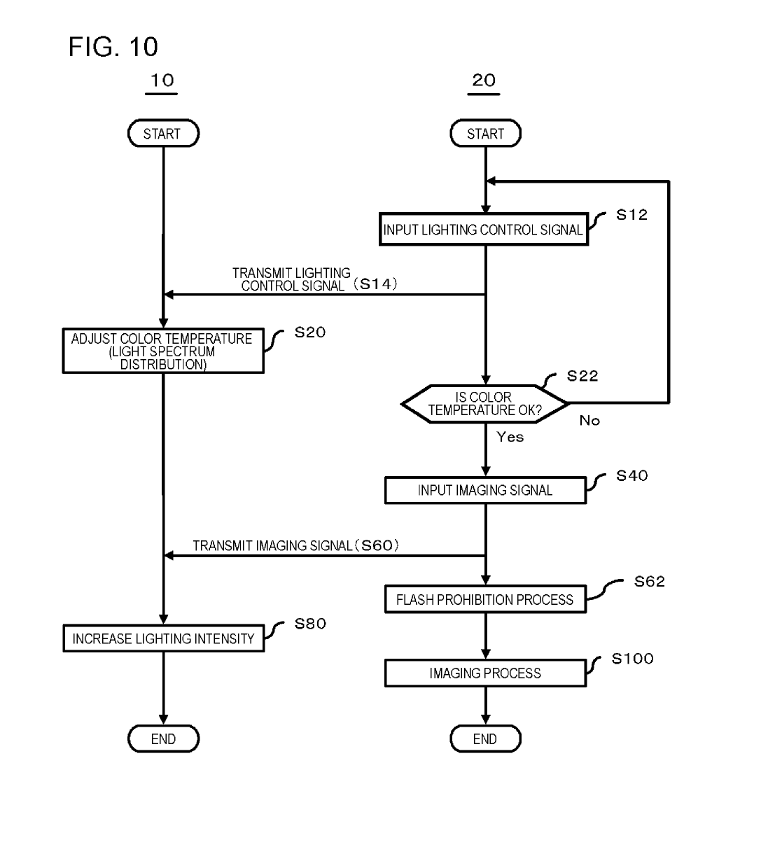

FIG. 10 is a flowchart illustrating an example of an operation of the imaging system according to this example. The operation shown in FIG. 10 is the same as in the flowchart shown in FIG. 6, except that an imaging process is performed (step S100) after the control section 260 of the imaging device 20 transmits an imaging signal to the light emitting device 10 (step S60) and then inhibits the operation of the flash section 225 (step S62).

In this example, similarly, since the flash section 225 is not operated when the imaging device 20 is operated together with the light emitting device 10, it is possible to reduce a difference between a spectrum distribution (first spectrum distribution) of light emitted to a photographic subject when viewing the photographic subject, and a spectrum distribution (second spectrum distribution) of light emitted to a photographic subject when imaging the photographic subject.

### Example 4

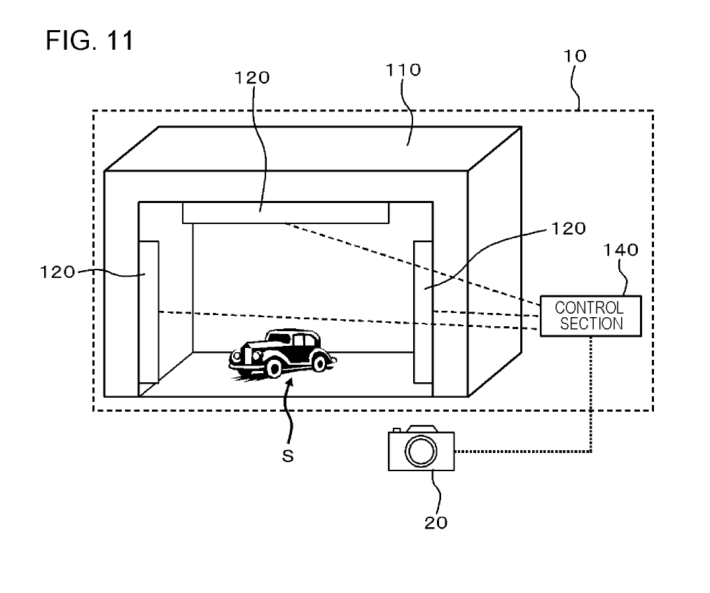

FIG. 11 is a diagram illustrating a configuration of an imaging system according to Example 4. The imaging system according to this example has the same configuration as the imaging system according to any one of the first embodiment and Examples 1 to 3, except that an imaging box 110 is included.

The imaging box 110 has a shape where one of side surfaces of a rectangular parallelepiped is open, for example. An inner surface of the imaging box 110 has a white color, for example. A photographic subject S is disposed inside the imaging box 110 through the opening.

Further, the lighting sections 120 are provided on the inner surface of the imaging box 110. In the example shown in FIG. 11, the lighting sections 120 are respectively provided on plural different surfaces. The control section 140 may independently control the plural lighting sections 120, or may control the plural lighting sections 120 in the same manner.

In this example, similarly, it is possible to reduce a difference between the spectrum distribution (first spectrum distribution) of light emitted to a photographic subject when viewing the photographic subject and the spectrum distribution (second spectrum distribution) of light emitted to a photographic subject when imaging the photographic subject.

Hereinbefore, the embodiments and examples are described with reference to the accompanying drawings, but these embodiments and examples are only examples of the invention, and various configurations other than the above-described configurations may be employed.

1. A light emitting device comprising:
a lighting section that adjusts a light spectrum distribution and a light intensity and emits light to a target to be imaged by an imaging section; and
a control section that controls the lighting section,
wherein the control section emits light to the target before the imaging section performs imaging, and
increases a light emission intensity of the lighting section when the imaging section images the target.

2. The light emitting device according to claim 1,
wherein the control section
controls a light spectrum distribution of the lighting section before the imaging section performs the imaging, and
increases the light emission intensity of the lighting section while maintaining the light spectrum distribution of the lighting section when the imaging section images the target.

3. The light emitting device according to claim 2,
wherein the lighting section includes a plurality of types of light emitting elements, each of the types of the light emitting elements having different light spectrum distributions, and
wherein the control section
individually controls electric current that flows in each of the plurality of types of light emitting elements, and
increases, when the imaging section images the target, the amount of the electric current that flows in each of the plurality of types of light emitting elements while maintaining a relative ratio of the amounts of the electric current that flows in each of the plurality of types of light emitting elements before the imaging section performs the imaging.

4. The light emitting device according to claim 3,
wherein the control section receives an imaging signal indicating that the target will be imaged from the imaging section, and increases the light emission intensity of the lighting section in response to the imaging signal.

5. The light emitting device according to claim 4, further comprising:
the imaging section.

6. An imaging device used together and a light emitting device, the light emitting device comprising:
a lighting section that adjusts a light spectrum distribution and a light intensity and emits light to a target to be imaged by an imaging section; and
a control section that controls the lighting section according to a signal received from the imaging device, and
the imaging device comprising:
an imaging section that images the target;
an imaging signal generation section that generates an imaging signal indicating that a light emission intensity of the lighting section will be increased in response to receipt of a signal indicating that the target will be imaged; and
a transmission section that transmits the imaging signal to the light emitting device.

7. The imaging device according to claim 6, further comprising:
a lighting control signal generation section that generates a lighting control signal indicating a spectrum distribution of light to be illuminated by the lighting section before the imaging section performs imaging,
wherein the transmission section transmits the lighting control signal to the light emitting device.

8. The imaging device according to claim 7, further comprising:
a touch panel type display section that displays an image generated by the imaging section,
wherein the lighting control signal generation section performs a display for input of the light spectrum distribution in the display section, and
wherein the imaging signal generation section performs a display for input of the signal indicating that the target will be imaged in the display section.

9. The imaging device according to claim 8, further comprising:
a flash section that emits light when the imaging section generates image data,
wherein the imaging signal generation section inhibits operation of the flash section when the imaging signal is transmitted.

10. A non-transitory computer-readable medium including instructions for use in an imaging device with a light emitting device,
the light emitting device comprising:
a lighting section that adjusts a light spectrum distribution and a light intensity and emits light to a target to be imaged by an imaging section; and
a control section that controls the lighting section according to a signal from the imaging device, and
the instructions comprising:
generating an imaging signal indicating that a light emission intensity of the lighting section will be increased based on a signal indicating that the target will be imaged; and
transmitting the imaging signal to the light emitting device.

11. A non-transitory computer-readable medium having instructions for controlling a light emitting device including a lighting section and a control section containing, the instructions comprising:
adjusting a light emission intensity during a viewing of a target based on a first command from the control section, and
in response to an instruction to image the target, increasing the light emission intensity of the lighting section while maintaining a color temperature of the lighting section based on a second command from the control section.

12. The non-transitory computer-readable medium of claim 11, wherein the instruction to image the target is received from a user input device.

13. A light emitting device comprising:
a lighting section having one or more light emitting elements configured to emit a light with respect to a target, and to provide a flash during an imaging of the target; and
a control section that adjusts a light emission intensity of the lighting section, such that the flash increases a light emission intensity of the lighting section while maintaining a color temperature of the lighting section.

14. The light emitting device of claim 13, further comprising an imaging box having an open side surface, and an interior surface, the target being positioned inside of the box through the open side surface,
wherein the lighting section is provided on the interior surface of the imaging box, and is controlled by the control section.

15. The light emitting device of claim 13, wherein the lighting section and the control section are commonly located.

16. The light emitting device of claim 13, wherein the lighting section is separate from the control section.

17. The light emitting device of claim 13, further comprising a switch that switches between a first mode in which a flash emits light when the imaging section generates data, and a second mode in which the flash generates the independently of whether the imaging section generates data.

18. The light emitting device of claim 13, wherein the lighting section includes a plurality of types of light emitting elements emitting colors different from each other, and the control section adjusts the color temperature of the lighting section.

19. The light emitting device of claim 13, wherein the control section adjusts the color temperature of the lighting section in response to a user-generated lighting control signal.

20. The light emitting device of claim 13, wherein the one or more light emitting elements comprise one or more light emitting diodes (LEDs).

21. The light emitting device of claim 13, further comprising a switch that switches functions of the lighting section, wherein one of the functions is the light with respect to the target, and another of the functions is the flash during the imaging of the target.
